(19) United States
(12) Patent Application Publication
(10) Pub. No.: US 2008/0189410 A1
(43) Pub. Date: Aug. 7, 2008

(54) DIRECTING A NETWORK TRANSACTION TO A PROBE

(75) Inventors: Gayle L. Noble, Boulder Creek, CA (US); David Russell Freeman, Milpitas, CA (US)

Correspondence Address: WORKMAN NYDEGGER, 60 EAST SOUTH TEMPLE, 1000 EAGLE GATE TOWER, SALT LAKE CITY, UT, 84111, US

(73) Assignee: FINISAR CORPORATION, Sunnyvale, CA (US)

(21) Appl. No.: 12/022,880

(22) Filed: Jan. 30, 2008

Related U.S. Application Data
(60) Provisional application No. 60/887,732, filed on Feb. 1, 2007.

(51) Int. Cl. G06F 15/16

(52) U.S. Cl. 709/224

(57) ABSTRACT

A method and apparatus for directing an entire network transaction to a network analysis device are disclosed. The apparatus can include an input port configured to receive network data from an inter-switch-link (ISL). The apparatus can further include a first probe port configured to transmit network data a second network analysis probe. The apparatus can further include a second probe port configured to transmit network data to a second network analysis probe. The apparatus can include one or more processors having access to instructions that cause the at least one processor to identify a field in the network data received by the at least one input port, the field associating the network data with a particular network transaction, assign the particular transaction to one of the first or second probes, and cause the network data to be transmitted to the assigned first or second probe.

### CROSS-REFERENCE TO RELATED APPLICATIONS

This application claims the benefit of U.S. Provisional Patent Application Ser. No. 60/887,732, filed Feb. 1, 2007, and entitled DIRECTING A NETWORK TRANSACTION TO A PROBE, the contents of which are incorporated herein by reference.

### BACKGROUND

Modern computer technology has resulted in a world where large amounts of electronic digital data are transferred between various electronic devices, also referred to as nodes. Examples of computer networks include small local networks such as home or small office networks to large ubiquitous networks such as the Internet. Networks may be classified, for example, as local area networks (LANs), storage area networks (SANs) and wide area networks (WANs). Home and small office networks are examples of LANs. SANs typically include a number of servers interconnected where each of the servers includes hard-drives or other electronic storage where data may be stored for use by others with access to the SAN. The Internet is one example of a WAN.

A network analyzer is a device that captures network traffic and decodes it into a human readable form. Software can then be used to read traces captured by the analyzer. The software can also recognize abnormalities, patterns, or events such that the network analyzer can begin capturing network data for analysis and storage.

A probe may capture metrics that describe, in general parameters, what is occurring with the network data. Such metrics may include, for example, a measurement of the amount of traffic on a network, where network traffic is coming from or going to, etc. The metrics may be streamed to a storage device. The captured network data and/or metrics can then be analyzed to identify performance and/or error metrics.

One challenge with capturing network data for analysis relates to capturing all the data representing an entire transaction. The challenge of capturing network data representing entire transactions is exacerbated due to load balancing performed by switches within the networks. Currently, packets of network data making up a transaction are transmitted by various different outputs of a switch and along different paths within the network often based on load balancing. Thus, as a result of the load balancing within networks, different portions of transactions may not travel through a network across the same links of the network. As a result, a need arises to access network data on a network at several different points in the network. In such instances, multiple network analyzer taps and probes must be used in multiple locations in a single network to ensure that all of the data representing a transaction is received and analyzed.

Use of multiple network taps and probes is quite expensive and introduces additional complications into network hardware setup, as well as analysis of network data. In response, applications have also been developed for “roving” across multiple nodes of a network to sample the data at each node so that data received from each node can be included in the network analysis. However, the data resulting from such roving still presents only an incomplete sampling of each transaction sent over a network. As such, there is a need to improve the capture of network data for analysis.

### BRIEF SUMMARY OF SEVERAL EXAMPLE EMBODIMENTS

A tap is disclosed which includes at least two input ports configured to receive network data from inter-switch-links (ISLs). The tap further includes a first probe port configured to transmit network data to a first network analysis probe. The tap further includes a second probe port configured to transmit network data to a second network analysis probe. The tap further includes at least one processor having access to instructions that cause the at least one processor to identify a field in the network data received by the at least one input port, the field associating the network data with a particular network transaction, assign the particular transaction to one of the first or second probes, and cause the network data to be transmitted to the assigned first or second probe.

A method for directing network data to one of multiple probes is disclosed. The method includes receiving network data from all inter-switch links in a network. The method further includes hashing a field in the network data to generate a hashing value associated with a transaction to which the network data belongs. The method further includes assigning the hash value to a network probe. The method further includes transmitting the network data to the assigned network probe along with all other network data associated with the same transaction and analyzing all of the network data of the transaction.

These and other features of the present invention will become more fully apparent from the following description and appended claims, or may be learned by the practice of the invention as set forth hereinafter.

### BRIEF DESCRIPTION OF THE DRAWINGS

To further clarify the above and other features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example of a network;

FIG. 2 illustrates an example of a tap according to the invention;

FIG. 3 illustrates a tap coupled to several probes where one or more transactions (identified by a particular source and destination) have been associated with each probe;

FIG. 4 illustrates a portion of tap according to the invention;

FIG. 5 illustrates an example of a tap according to the invention; and

FIG. 6 illustrates a method for directing network data to a probe based on a transaction to which the network data belongs.

### DESCRIPTION OF SEVERAL EMBODIMENTS

The principles of the embodiments described herein describe the structure and operation of several examples used to illustrate the present invention. It should be understood that the drawings are diagrammatic and schematic representations of such example embodiments and, accordingly, are not limiting of the scope of the present invention, nor are the drawings necessarily drawn to scale. Well-known devices and processes have been excluded so as not to obscure the discussion in details that would be known to one of ordinary skill in the art.

Several of the embodiments disclosed herein relate to directing data packets making up an entire transaction sent across multiple switches in a network to a single probe or other network analysis device. Several embodiments include an apparatus, often referred to herein as a tap, that receives all outputs from a switch, assigns a particular network analysis device to each transaction, identifies the various packets making up each transaction, and routes all of the packets of each transaction to the assigned network analysis device. Accordingly, each assigned network analysis device receives complete transactions for performing network analysis.

In some embodiments, hashing functions can be used to associate the packets of each transaction to an assigned network analysis device. This can be accomplished using one, two, or more processing devices, for example. In some embodiments, a first processing device can hash data identifying a transaction to which the network data belongs and a second processing device can direct data to the assigned analysis device.

Several taps disclosed herein direct network data to probes based on information within the network data identifying a transaction to which the network data belongs. The identifying information can be located at a known location within the packets of network data and can include ITL or IP addresses, for example. For example, an initiator/target/LUN (“ITL”) field of each packet of network data can be hashed.

A second processing device can control distribution of the packets of network data to the various analysis devices based on the hashed fields. Therefore, the second processing device can also control some aspects of load balancing between the network analysis devices.

Some embodiments include taps that monitor all of the inter-switch links (ISLs) in a network and direct packets of network data to one or more probes of network analyzers according to a transaction to which the packets of data belong. One example of a network analyzer is the NetWisdom performance monitoring tool by Finisar Corporation based in Sunnyvale, Calif. The NetWisdom network analyzer, for example, includes a three-tiered architecture consisting of probes, portal, and views. Probes include hardware that connects to the SAN data paths via the taps disclosed herein. Portals include software that collects data from the probes. Views include software that presents the data in a flexible graphical user interface.

Probes can be connected to the network via the taps disclosed herein and gather all of the transactions at the ITL level (host to storage conversations), providing detailed statistics on the network's performance. The portal is a self managing database that gathers data from probes and stores the data for viewing and analysis. The portal collects statistics and aggregates them over time according to user-defined schedules. Portals also allow alarms to be set that specify actions to be carried out when pre-determined thresholds are breached. Additional software can be used to view, analyze, and process data collected by the portal, yielding a consolidated picture of overall network traffic.

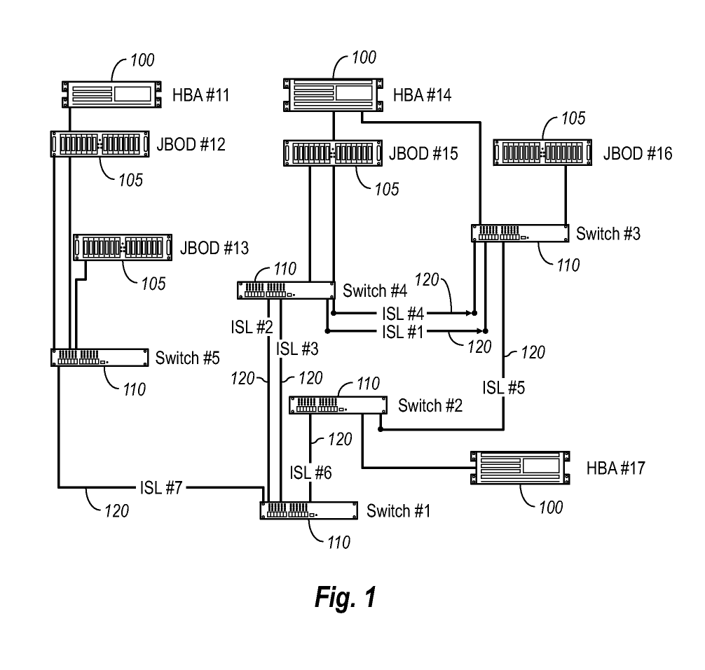

Referring to FIG. 1, an example of a network is illustrated. In this example, the network includes various interconnected network devices such as host bus adapters (HBAs) 100, storage devices (JBODs) 105, and switches 110. In between the switches 110 are links referred to as ISLs 120. In the example of FIG. 1, seven ISLs 120 are shown interconnecting the various switches 110. As can be appreciated by the example illustrated in FIG. 1, packets of network data collectively constituting a single transaction may travel across several different ISLs 120 to arrive at the intended network device destination. Thus, one problem is that the data from all ISLs is needed to verify a transaction has completed as all of the transactions did not go over one ISL. For example, a first packet making up a portion of network transaction sent by HBA #11 to JBOD #16 can be communicated through switch #5, switch #1, switch #2, and switch #3 before arriving at JBOD #16. A second packet constituting another portion of the same network transaction can be communicated through switch #5, switch #1, switch #4, and switch #3 before arriving at JBOD#16. Thus, different portions of the same transaction may take different paths through a network as the portions of the same network transaction are communicated from a source to a destination of the network.

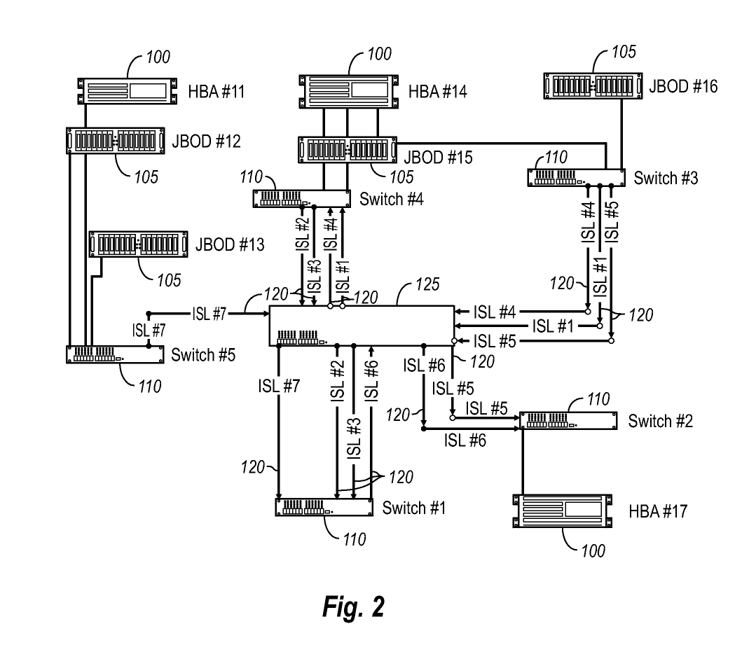

Referring to FIG. 2, an example of a tap 125 is illustrated according to an example embodiment. As shown, each ISL 120 is coupled to the tap 125. In this manner, all of the data transmitted on the ISLs 120 of the network are transmitted through the tap 125. Therefore, the tap 125 can identify and associate network data belonging to each transaction and direct all of the network data for each transaction to the same probe. As a result, the associated probe is able to conduct network analysis on an entire transaction rather than only receiving a portion thereof. According to the teachings herein the network data can be collected wirelessly, wired, or by other means. Therefore, where a wired port may be discussed herein, it should be understood that a wireless connection can also be used.

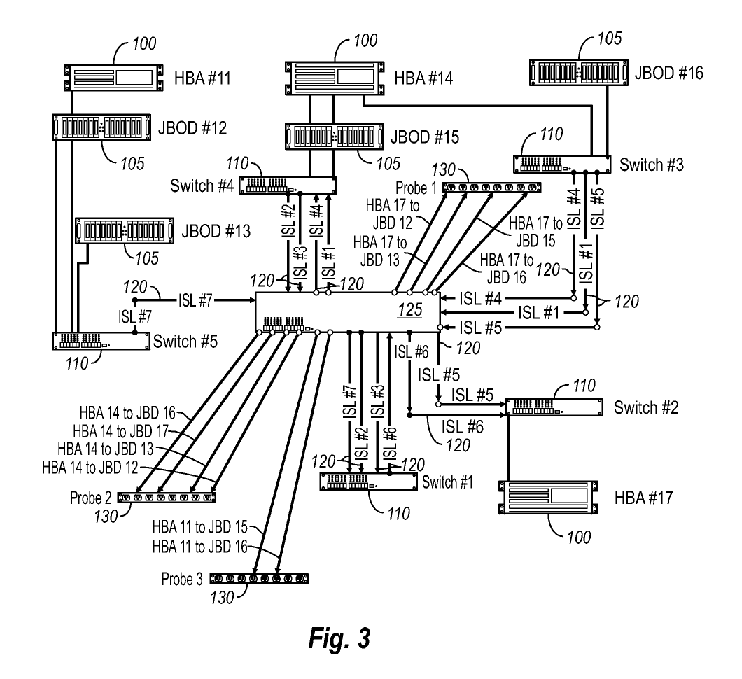

Referring to FIG. 3, an embodiment is illustrated where the tap 125 is coupled to several probes 130 and has associated one or more transactions (identified by a particular source and destination) with each probe 130. In the example shown in FIG. 3, the tap 125 has associated transactions between HBA 14 and JBOD 16 with probe 2, transactions between HBA 14 and JBOD 17 with probe 2, and so on until each transaction received by the tap 125 is directed to a particular probe 130.

For example, as shown in FIG. 3, packets of data constituting transactions between HBA 17 and JBOD 12, between HBA 17 and JBOD 13, between HBA 17 and JBOD 15, and transactions between HBA 17 and JBOD 16 are all sent to the first probe (Probe 1) 130. Therefore, the first probe 130 receives complete transactions sent by HBA 17 for network analysis. Similarly, packets of data constituting transactions between HBA 14 and JBOD 16, between HBA 14 and JBOD 17, between HBA 14 and JBOD 13, and transactions between HBA 14 and JBOD 12 are all sent to the second probe (Probe 2) 130. Therefore, the second probe 130 receives complete transactions sent by HBA 14. Finally, the third probe (Probe 3) receives packets of data originating at HBA 11. For example, the third probe receives entire transactions sent from HBA 11 to JBOD 15 and from HBA 11 to JBOD 16. As such, network analysis may be conducted on complete transactions sent by HBA 11 via the third probe. Additional probe connections and ISL connections may be added depending on the extent of the network and the number of desired access points.

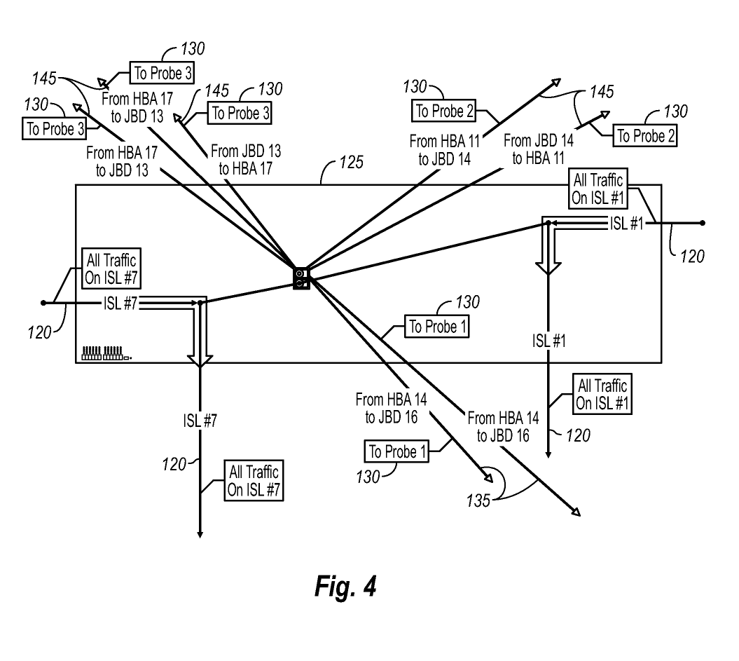

Referring to FIG. 4, an illustration of a portion of tap 125 is shown. As previously discussed, the tap 125 receives all traffic on all ISLs 120 of a network. For example, as illustrated in FIG. 3, the tap 125 receives all of the traffic from ISL 1 and ISL 7 as well as other ISLs 120 (not shown, see FIG. 2) in the network. The tap 125 identifies data belonging to each transaction and assigns a network probe 130 to each transaction. The tap 125 then forwards the entire transaction to the assigned network probe 130. For example, each transaction can be identified based on a field within the data. The field may be an ITL, IP address, or other information describing a transaction to which the network data belongs. Each transaction may be associated with a particular source and destination within the network. For example, the source and destination may be network devices within the network between which the data is transferred thereby defining a transaction.

As shown in the embodiment of FIG. 4, two transactions 135 are assigned to probe 1, two transactions 140 are assigned to probe 2 and three transactions 145 are assigned to probe 3. The number of transactions assigned to each probe 130 can be controlled by the tap 125 and may be based on load balancing between the various probes 130 coupled to the tap 125. In this manner the tap 125 can control the number of transactions and amount of network data assigned to each probe 130. For example, the transactions assigned to each probe 130 can be controlled based on an amount of network data analyzed by each probe 130, a type of analysis performed by each probe 130, the type of probe 130 assigned the network transactions, capabilities of each probe 130, or any other criteria. As such, the tap 125 can assign transactions to probes 130 so as to optimize analysis of the network data.

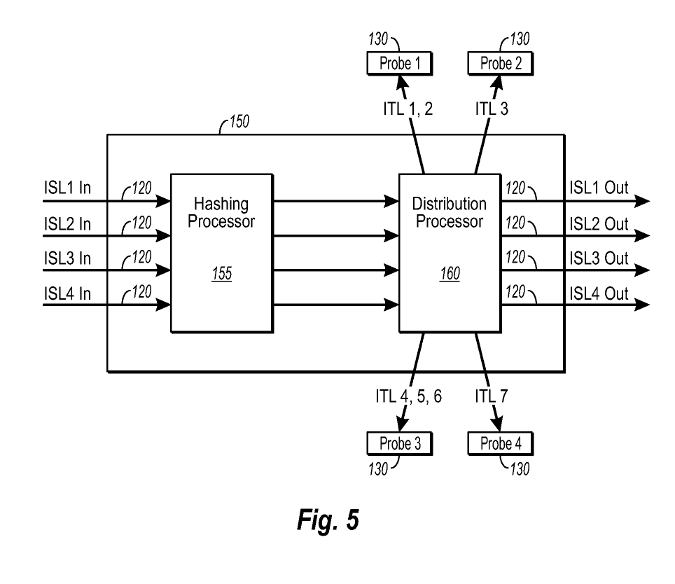

Referring to FIG. 5, an example of a tap 150 is illustrated according to an example embodiment. In this example, the tap 150 is connected in-line with a network including 4 ISLs 120. As shown, each ISL 120 is connected to the tap 150 such that network data is transmitted to the tap 150 and from the tap 150 so that the network data is not disrupted from being transmitted between its intended source and destination in the network.

According to the example illustrated in FIG. 5, the network data is received by a hashing processor 155. The hashing processor 155 identifies an ITL in the network data associating the network data with a particular transaction. The hashing processor 155 hashes the ITL using a hash function. A hash function (or hash algorithm) is a reproducible method of turning data, such as an ITL or ISP address, into a number suitable to be handled by a processor. Hashing functions provide a way of creating a small digital “fingerprint” from any kind of data that associates the network data with the transaction to which the network data belongs, also known as a hash value. The hash value for each piece of network data can then be incorporated (e.g. written) into the network data, or otherwise communicated to a distribution processor 160 that controls the assignment and distribution of transactions to the various probes 130 connected to the tap 150.

The network data is transmitted from the hashing processor 155 to the distribution processor 160 along with the hash value associated with the respective transaction. The distribution processor 160 assigns a probe 130 to the hash value of the network data if a probe 130 has not already been assigned to the particular hash value. The network data is transmitted to the assigned probe 130 based on the network data's hash value. As a result, all of the network data associated with each particular transaction is transmitted to the same probe 130.

The number of transactions assigned to each probe 130 can be controlled by the distribution processor 160 and can be based on load balancing or any other criteria as discussed above. The distribution of transactions can also be monitored and controlled externally via a signal received from a under input device. As shown in the example illustrated in FIG. 5, transactions associated with hash values for ITLs 1 and 2 are assigned to probe 1, a transaction associated with a hash value of ITL 3 is assigned to probe 2, transactions associated with hash values for ITLs 4, 5, and 6 are assigned to probe 3, and a transaction associated with a hash value for ITL 7 is assigned to probe 4. It is understood that such assignments are made herein by example only and are in no way limiting of the invention. Thus, each probe 130 (or other device) can conduct network analysis using the network data of the assigned transactions received.

One type of processing device that may be used for hashing and/or distribution of network data to probes 130 is a field programmable gate array (FPGA). Also, the tap 150 is not limited to two processors, but may include one, two, three, or more processors for accomplishing any, or all, of the functions discussed herein.

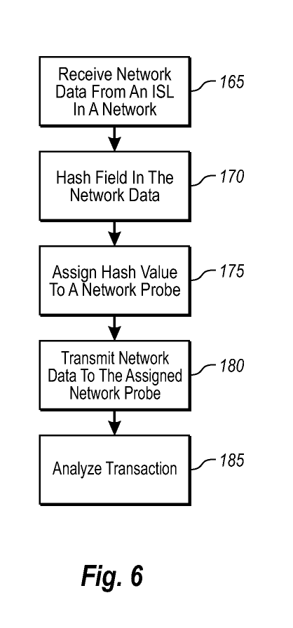

Referring to FIG. 6, a method is illustrated for directing network data to a probe based on a transaction to which the network data belongs. The network data is received from an ISL in a network (165). The network data can be a packet of data representing a portion of a transaction. The transaction can represent a communication of network data transmitted between two network devices. The network data may be a packet of network data that is communicated across an ISL between two network devices. In one example, the network data passes through one or more switches in the network Where portions of the same transaction are not transmitted across the same ISL. However, all of the network data from each ISL in the network is received such that all network data is received.

The method identifies a transaction to which the network data belongs. In one example, in order to determine one or both of the source address and the destination address, a field in the network data is hashed (170) using a hashing function to create a hashed value that is unique to the transaction to which the network data belongs. The field can be a field that includes information describing a source and destination between which the network data is being transferred. For example, the field can include an ITL or an IP address associated with a particular source and a particular destination. Thus, each piece of network data is associated with a hash value that associates the network data with a particular transaction to which each piece of network data belongs. The hash value can be incorporated into the network data or otherwise associated with the network data.

The hash value associated with the piece of network data is assigned to a network probe (175). For example, there may be several network probes and each hash value associated with a particular transaction can be assigned to one of the several network probes.

Prior to assigning the network data to a network probe, a processing load or a queue of one or more probes may be determined. For example, a signal may be received from each probe indicating a current amount of processing or network analysis being conducted, or an amount of data in a queue at each network probe. The load at each probe can be compared to identify a probe with the greatest bandwidth (i.e. the lowest load) and the transaction can be assigned based on this criteria. Other criteria for assigning transactions and associated hash values can be followed as discussed above and signals describing such criteria can be received.

The network data is transmitted to the network probe assigned to the hash value associated with the network data (180). Additional network data associated with the same hash value is also sent to the same network probe so that the network probe receives all of the network data of the assigned transaction.

At the various probes, all of the network data of the particular transaction is analyzed (185). Each transaction can be analyzed for performance issues. Alarms, and notifications may be triggered as a result of the analysis. The network data can be analyzed for policy-based data path management, monitoring of network devices, and monitoring performance within fabrics of the network. The network data can be analyzed for device discovery and monitoring (e.g., of storage, HBA and switch SAN devices) and detailed discovery of device properties and status including logical device properties (e.g., volume, logical unit number (LUN) map, zone, fabric, port, etc.). The network data can also be analyzed to identify vulnerabilities and other errors. Any other type of network analysis can also be performed by analyzing the network data.

In most cases a single tap connected to all of the ISLs will send the network data to the hash and distribution processors as well as having the network data pass though to its destination. In some embodiments, the network data can pass though the tap and be tapped off there and sent to the hashing and distribution processor(s). In some embodiments, only the header information from each transaction on each ISL will be sent to the processor(s). For example, the information tapped off the ISL can be routed by a wired or wireless connection to the processor that hashes the ITL field and forwards the data to the probes. The tap point can strip all but the headers off the network data before sending the data to the processor(s), or the processors can strip the headers and forward the rest of the data to the probes.

Embodiments of the device may include readable media for carrying or having executable instructions or data structures stored thereon. Such readable media can be any available media that can be accessed by a processing device. By way of example, and not limitation, such readable media can comprise RAM, ROM, EEPROM, CD-ROM or other optical disk storage, magnetic disk storage or other magnetic storage devices, or any other medium which can be used to carry or store desired program code in the form of executable instructions or data structures and which can be accessed by a processing device. Executable instructions comprise, for example, instructions and data which cause a computer, logic device, or other processing device to perform a certain function or group of functions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A tap comprising:
at least two input ports configured to receive network data from at least two inter-switch-links (ISLs);
a first probe port configured to transmit network data to a first network analysis probe;
a second probe port configured to transmit network data to a second network analysis probe; and
at least one processor having access to instructions that cause the at least one processor to perform the following acts:
identify a field in the network data received by the at least two input ports, the field associating the network data with a particular network transaction;
assign the particular transaction to one of the first or second probes; and
cause the network data to be transmitted to the assigned first or second probe.

2. An apparatus according to claim 1, wherein the instructions are further configured to cause the at least one processor to perform the following act:
perform a hashing function on the identified field of the network data to generate a hashing value associated with the particular transaction to which the network data belongs.

3. An apparatus according to claim 2, wherein the instructions are further configured to cause the at least one processor to perform the following act:
compare a load of each probe coupled to the at least two probe ports, wherein the hashing value is assigned to one of the first or second probes based on a result of the comparison of the load of each probe.

4. An apparatus according to claim 3, wherein the load is associated with a number of transactions assigned to each probe.

5. An apparatus according to claim 3, wherein the load is associated with a size of each transaction assigned to each probe.

6. An apparatus according to claim 3, wherein the at least one processor includes a field programmable gate array (FPGA).

7. An apparatus according to claim 3, wherein the at least one processor includes a hashing field programmable gate array (FPGA) configured to perform the hashing function and a distribution FPGA configured to direct the network data to the assigned probe.

8. An apparatus according to claim 7, wherein the distribution FPGA is further configured to assign a probe to the network data based on a hashing value received from the hashing FPGA.

9. An apparatus according to claim 1, wherein the field includes an initiator/target/LUN (ITL) field.

10. An apparatus according to claim 1, wherein the field describes a source device and destination device of the network data.

11. An apparatus according to claim 1, wherein the particular transaction is assigned to the first probe or the second probe based on a type of analysis conducted by the first and second probes.

12. An apparatus according to claim 1, wherein the particular transaction is assigned to the first probe or the second probe based on a type of each probe.

13. An apparatus according to claim 1, wherein the particular transaction is assigned to the first probe or the second probe based on a capability of each probe.

14. An apparatus according to claim 1, wherein the apparatus includes at least three input ports, each input port being connected to a different ISL of a network such that the apparatus is capable of being connected to every ISL of the network.

15. An apparatus according to claim 1, wherein the at least two input ports are configured to receive network data from the ISLs via wireless connections.

16. An apparatus according to claim 1, wherein the at least two input ports are configured to receive network data from the ISLs via wired connections.

17. A network analysis system comprising:
the apparatus of claim 1 including several input and output ports configured to couple to each inter-switch link of a network thereby receiving all of the network data of each transaction transmitted in the network; and
at least two network analysis probes coupled to respective probe ports.

18. A network analysis system according to claim 17, further comprising:
at least two portals coupled to respective probes and configured to collect the network data from the probe connected to the respective portal; and
software configured to present the network data in a graphical user interface.

19. A method for directing network data a one of multiple probes comprising the following acts:
receiving network data from all ISLs in a network;
hashing a field in the network data to generate a hashing value associated with a transaction to which the network data belongs;
assigning the hash value to a network probe;
transmitting the network data to the assigned network probe along with all other network data associated with the same transaction; and
analyzing all of the network data of the transaction.

20. A method according to claim 19, wherein the network data is received from each ISL via a wireless or wired connection.
